(19) United States
(12) Patent Application Publication
(10) Pub. No.: US 2017/0283230 A1
(43) Pub. Date: Oct. 5, 2017

(54) Foldable cork remover and extractor

(71) Applicant: PGD, LLC, Port St. Lucie, FL (US)

(72) Inventor: Pasquale Lamarra, Plant City, FL (US)

(21) Appl. No.: 15/086,255

(22) Filed: Mar. 31, 2016

(51) Int. Cl. B67B 7/04; B26B 11/00; G01J 5/00; B67B 7/10

(52) U.S. Cl. CPC B67B 7/0423; B67B 7/10; B26B 11/00; G01J 5/0037; B67B 2007/0488

(57) ABSTRACT

A foldable corkscrew comprised of a main body, a helical thread being introducible screwed into a cork, a lever arm serving as a fulcrum point against the neck of a bottle, and an extractor tool for removal of cork pieces floating within a bottle. The thread and extraction tool are attached to a first shaft, connected to the intermediate portion of the main body, for foldable connection of the thread and extraction tool relative to the main body. The lever is attached to a second shaft, connected to the second end of the main body, for foldable connection of the lever relative to the main body. The extraction tool, sized to fit within a bottle neck, has a proximal end attached to the first shaft and a distal end having a cup for containment of a cork and cork pieces.

### FIELD OF THE INVENTION

This invention relates generally to the field of wine bottle cork removers and, in particular, to an improved wine bottle opener having a cork extractor.

### BACKGROUND OF THE INVENTION

The wine bottle corkscrew is a common tool used in restaurants, homes and elsewhere for the removal of the corks used to seal wine bottles. Its actual significance relates directly to the characteristics of the cork itself and degree to which corks are used in the wine industry. Cork is a natural, impermeable, buoyant material harvested for commercial use for use with cork bottles. The primary source of cork is from an evergreen oak tree known as the Cork Oak which is endemic to Southwest Europe and Northwest Africa. Easily converted into a cylindrical shape, it is compressed upon insertion into a bottle where it expands to form a fluid tight seal. This is particularly important to bottlers of wine as the tight fit not only keeps the liquid from escaping, but also maintains a uniform concentration of air important for the proper maturing and preservation of the wine itself. Natural cork closures are used in about 80% of the 20 billion bottles of wine produced worldwide each year. Once inserted, the corks are compressed and difficult to grip or remove. Corkscrews are commonly used for removal of a cork from the bottle.

Aside from the obvious job of removing the cork, the most important issues to consider in choosing a corkscrew include a device that: require as little brute force as possible to cause removal of the cork; ability to keep the cork intact (no breakage, shredding, etc.); ability to cause the screw to go in straight to avoid breaking the cork; cork removal should not shake up the bottle to avoid disturbing the sediment, if any; and the ability to fit all types of bottle necks. There are a number of corkscrews that attempt to address some aforementioned needs ranging from the simple “T” corkscrew to more elaborate mechanical devices that rely on levers, gears, threads, gas pressure, hooks and prongs, and rack and pinion mechanisms.

Generally, a corkscrew consists of a pointed metallic helix (often called a worm) attached to a handle. The most basic type of cork remover is a simple corkscrew. A horizontal handle is paired with a vertical pointed metallic helix. The helix comes to a sharp point at the end. Removing the cork from a wine bottle is accomplished by twisting the helix into the wine cork until it is firmly anchored. Holding the bottle firmly in hand, the handle is used to pull the cork upward thereby releasing the cork from the bottle. A second basic type of corkscrew is the wing corkscrew, also referred to as butterfly corkscrew, an angel corkscrew, or a screwpull. The wing corkscrew has two frame pieces, one on either side of the helix. The frame is used to center the helix as the frame is held tightly around the bottle's neck. If executed well, the screw enters the cork's center and when it is completely anchored in the cork, each turn of the handle moves the cork up by a pitch distance of the helix. The disadvantage of both the “T” corkscrew and the wing corkscrew is the amount of strength required to pull the cork from within the bottle neck, as well as the risk of screwing through the bottom of the cork and releasing cork bits into the wine.

Corks are used as stoppers for a variety of bottles. The corks are generally inserted into the opening of the neck of the bottle until the cork is flush with the top of the opening of the bottle. As discussed above, corkscrews have long been used to remove the cork stoppers. But the problem with the prior art corkscrew devices is that the downwardly extended pressure typically applied to the cork during removal may cause a cork to be pushed down through the neck of the bottle leaving an intact cork out of reach and floating in the wine. Attempts have been made to design tools for extracting trapped intact corks from bottles, such as U.S. Pat. No. 199,760 and U.S. Pat. No. 120,830. These cork extracting devices can be effective, but they also suffer from a variety of disadvantages. For example, those with a single loop are difficult to center around a floating cork. The '760 and '830 devices use multiple loops, but they are attached together at their ends, which makes them difficult to manipulate around a cork.

The double lever corkscrew is a device that uses a gear and rack mechanism to convert the handles into efficient levers when pulling the cork. As the helix is screwed into the cork, the two levers move from a parallel vertical position on either side of the helix to a horizontal position. Once both levers are fully horizontal, pressure is exerted using one or both hands to push them back into the original vertical position. As the levers return to their vertical positions, the helix removes the cork from the mouth of the bottle. Unfortunately, the double lever corkscrew is not compact and so not easily stored away.

The “prong” type cork puller focuses more on gripping the cork. A horizontal handle has two metal prongs, typically of uneven lengths, spaced out to about the diameter of the inside of the mouth of a bottle. The prongs are slid down between the cork and the bottle neck by tilting the handle back and forth in a rocking fashion until the prongs are completely inserted thereby loosening the cork from the interior wall of the neck. After a couple of revolutions, the friction will have allowed for the cork to be gripped by the prongs and pulled up and out of the bottle. However, these cork pullers require a degree of brute force to insert the prongs between the cork and the bottle neck, then upward pulling effort to remove the cork, creating a degree of skill, force, and experience with use.

Certain hand-held corkscrew mechanisms have a bottle clamp that holds the bottle neck while the corkscrew is inserted into the cork, and a lever, which typically swings over the top and removes the cork from the bottle neck. The hand-held corkscrew mechanisms are very effective in removing a cork, but are extremely expensive and bulky, thereby not fitting into compact storage spaces.

A sommelier knife, Waiter's corkscrew, or wine key features a corkscrew in a folding body. It relies on the leverage principle. This piece folds into a neat little package that is easily pocketed when not used. The corkscrew is manually screwed into the center of the cork. Then, the bottle rest is placed onto the lip of the bottle and the long end of the corkscrew is lifted up to give a mechanical advantage before the long handle is pushed down thereby removing the cork. Overall, foldable corkscrews do a great job in removing a cork, cost very little, and require little skill to use effectively. The foldable nature of the Waiter's corkscrew led to the addition of wine bottle accessories attached thereto, most notably a knife for removal of the foil on the outside of the top of the bottle neck.

However, improper storage of wine bottles may cause the corks to become dry and friable. The removal of damaged, dry, broken or otherwise defective corks has become common. A friable or otherwise defective cork, may crumble and break during the removal attempts using the prior art devices. A broken section of the cork may remain lodged within the neck of the bottle and may not be retrieved with the prior art corkscrews. Generally, in this situation, the user pushes the cork down into the bottle where it remains while the content of the bottle is emptied. This, however, may present problems insofar as when the bottle is still full the floating cork may impede easy pouring of liquid from the bottle, frequently leading to spillage.

Should the cork be removed yet leave cork bits in the wine, the best way to remove the bits is to pour the wine through a filter into a clean and empty container (decanter, carafe, or pitcher). Filters designed specifically for wine, such as a vinturi wine filter screen, exist in the prior art.

Accordingly, there is a need for an improved corkscrew having a cork extractor attached thereto that can be used for removing whole corks or pieces left behind that are floating in the wine.

### SUMMARY OF THE INVENTION

The foldable corkscrew comprised of a cork remover and extractor. The corkscrew includes a main body, a helical thread being introducibly screwed into a cork embedded in a bottle, a lever arm serving as a fulcrum point against the neck of a bottle when removing a cork, and an extractor tool for removal of a cork or cork pieces floating within a bottle. The main body has a first end, second end, and an intermediate portion. The helical thread and extraction tool are attach to a first rotatable shaft, connected to the intermediate portion of the main body, for foldable connection of the helical thread and extraction tool relative to the main body. The lever arm is attached to a second rotatable shaft, connected to the second end of the main body, for foldable connection of the lever arm relative to the main body. The extraction tool has a proximal end attached to the first shaft and a distal end having a cup for containment of a cork and cork pieces. The cup has an open top, for introduction of the cork and cork pieces. The extraction tool is sized to fit within a bottle neck.

Accordingly, it is an objective of the instant invention to provide a multipurpose corkscrew.

It is a further objective of the instant invention to provide a corkscrew that includes an extractor of broken corks.

It is yet another objective of the instant invention to provide a foldable corkscrew that allowing for compact storage.

It is further an objective of the instant invention to provide a foldable corkscrew having an extractor tool capable of removing an intact cork as well as a broken cork having pieces floating in the wine.

Other objectives and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1 is a perspective view in an open position of the foldable corkscrew of the instant invention;

FIG. 2 is a perspective view in a folded position of the foldable corkscrew of the instant invention;

FIG. 3 is a top view of the foldable corkscrew of the instant invention;

FIG. 4 is a side view of the foldable corkscrew of the instant invention;

FIG. 5 is a bottom view of the foldable corkscrew of the instant invention;

FIG. 6 is left view of the foldable corkscrew of the instant invention;

FIG. 7 is right view of the foldable corkscrew of the instant invention;

FIG. 8 is an in use pictorial representation of the foldable corkscrew of the instant invention; and

FIG. 9 is a perspective view of an alternative embodiment of the foldable corkscrew of the instant invention.

### DETAILED DESCRIPTION OF THE INVENTION

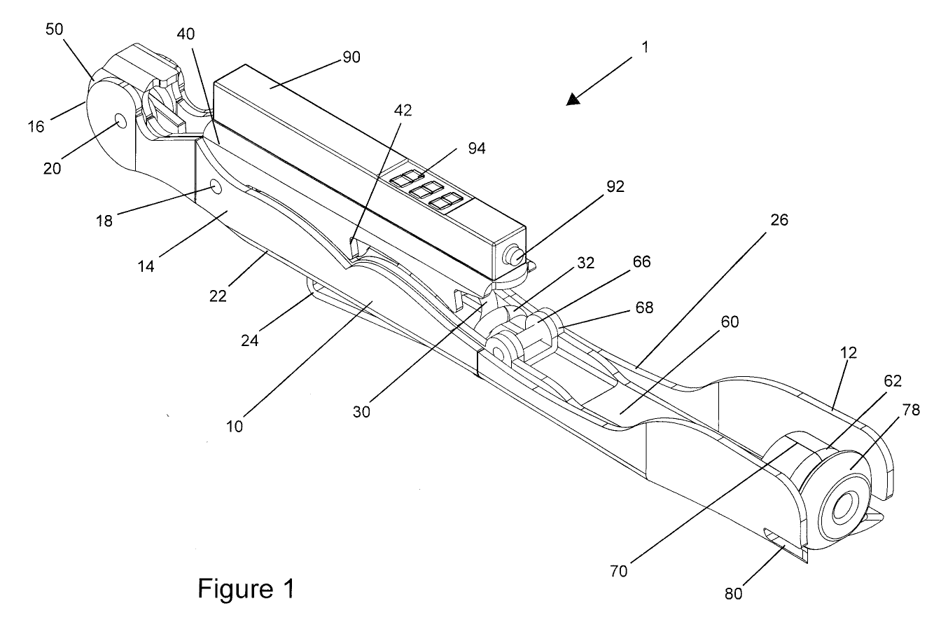

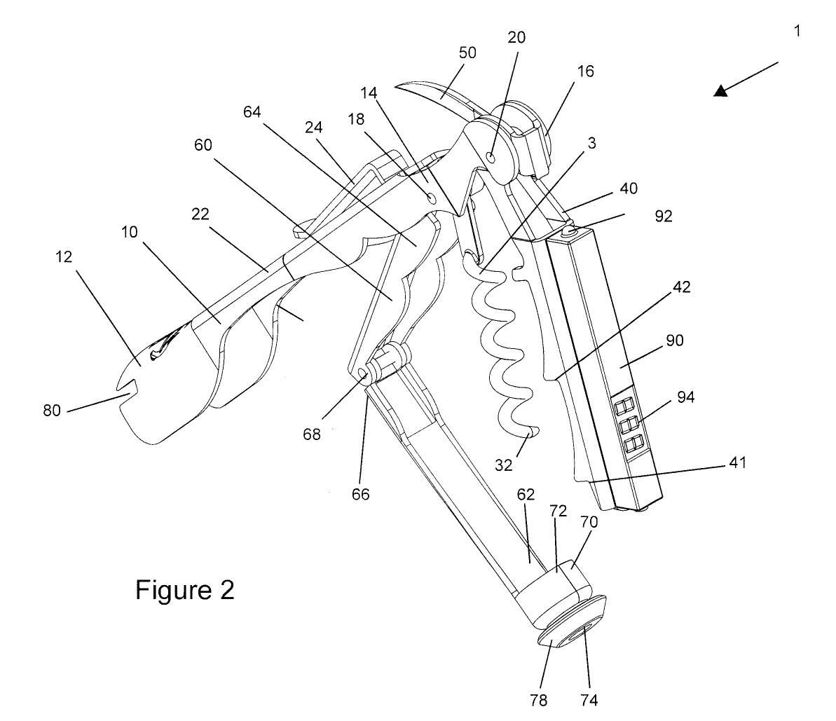

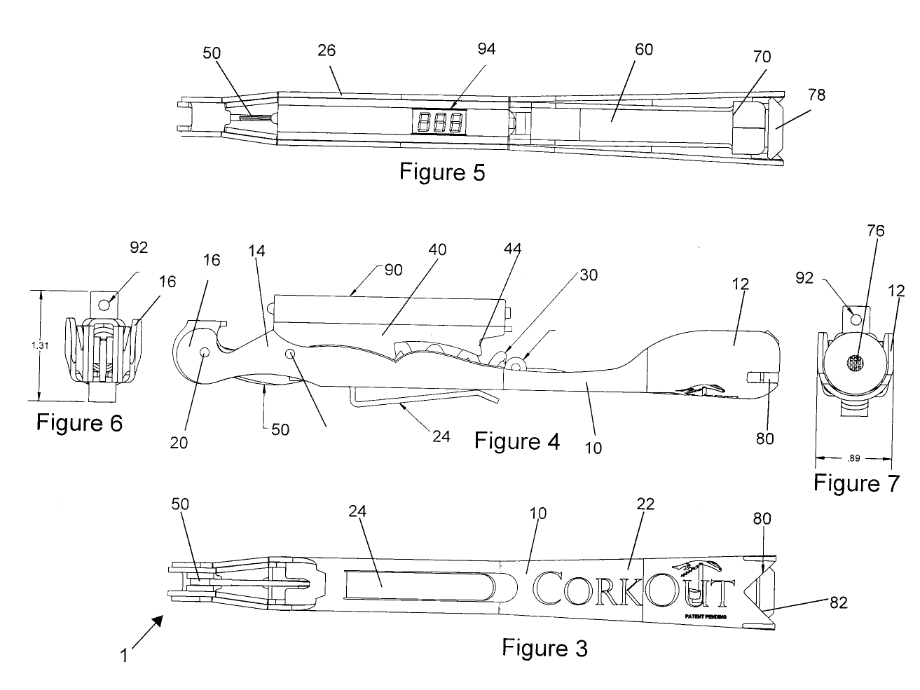

As shown in FIGS. 1-7, the foldable corkscrew 1 is comprised of a main body 10 having a helical thread corkscrew 30 of conventional design used to screw into a cork 104 embedded in a bottle 100. A lever arm 40 serves as a fulcrum point having notches 41 and 42 for use in biasing against the neck 102 of a bottle 100 when removing a cork 104. An extractor tool 60, explained in more detail below, is used for removal of cork pieces floating within the bottle 100 should the cork crumble. Additional accessories include a knife 50 for removal of foil typically found on the outside of the top of the bottle neck 102 and a thermometer for determining the exact temperature of the wine. A wine bottle wire/foil remover 80 formed along a first end 12 of the main body 10. On a top surface 22 of the main body 10 a belt clip 24 is attached allowing ease of mounting to a server's belt or clothing.

The main body 10 operates as a handle for the user. The main body 10 is ergonomically shaped to accommodate the contours of a user's hand and is defined by a first end 12, a second end 16, and an intermediate portion 14. The main body 10 further includes a top surface 22 and a U-shaped bottom surface 26 that operates to conceal the extractor tool 60 between the lever arm 40. The material of construction is preferably stainless steel or the like dishwater safe materials. It should be noted that plastic can be used, but is not recommend for the helical thread corkscrew 30. Similarly, the belt clip 24 can be formed of materials other than metal. On the first end 12 of the main body 10 is included a wine bottle foil remover 80 which is a slot 82 for use in engaging a foil wire for leverage twisting or break away. The slot 82 has a sharp edge 84 for cutting of foil wire to assist in removal. The slot 84 is constructed and arranged to meet at two points along the neck of the bottle 102. Thereby the circular manipulation of the main body 10 having the slot 82 in contact with the foil, will remover the foil from the wine bottle 100, not shown.

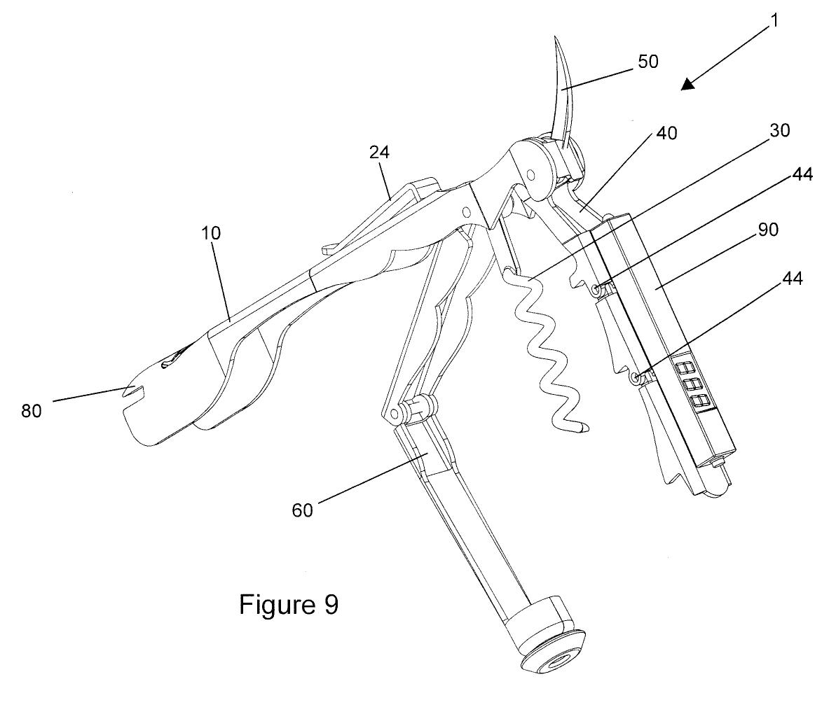

The helical thread corkscrew 30 is attached to a first pivot shaft 18 which is connected to the intermediate portion 14 of the main body 10 and allows for foldable connection of the helical thread 30 relative to the main body 10. The helical thread 30 has a pointed end 32 which is introducibly screwed into a cork to be removed from a bottle 100. The helical thread corkscrew 30 pivots outward when in use. The handle 10 and lever arm 40 are pivoted into a t-position to allow for ease of rotation necessary for insertion and removal of a cork. The lever arm 40 is connected to the main body by a second pivot shaft 20 along the second end 16 of the main body 10 and allows for foldable connection of the lever arm 40 relative to the main body 10. The lever arm 40 has notches 41 and 42 that serve as a fulcrum point when placed against the neck 102 of a bottle 100 when removing a cork 104, not shown. It is contemplated that the lever arm 40 may include additional notches to allow for a multitude of fulcrum points in removal of a cork 104. It is further contemplated that the lever arm may contain pivotable sections 44 to accommodate oddly shaped bottle necks 102, as shown in FIG. 9. A knife 50 is also attached to the second pivot shaft 20 permitting a foldable connection relative to the top surface 22 of the main body 10.

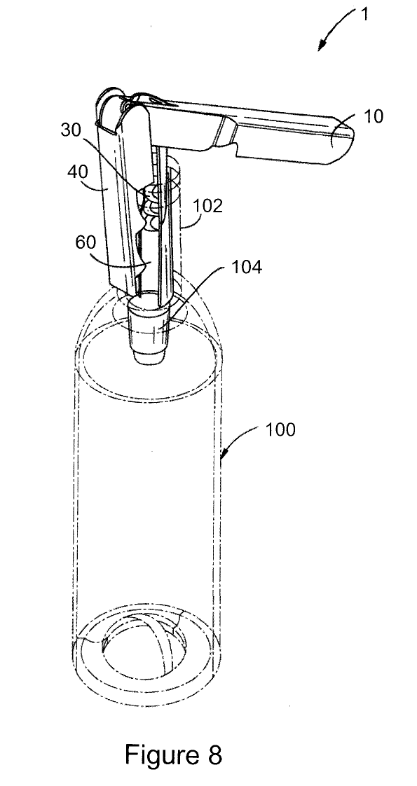

The unique aspect of this invention is directed to the extraction tool 60 which has an upper body 64 attached to the first pivot shaft 18 and a lower body 62 coupled along a pivot point 68 which allows for the foldable connection of the extraction tool 60 relative to the main body 10. The lower body includes a cup 70 shaped containment area for capturing of cork pieces. The upper and lower body are sized to fit within the bottle neck 102 as illustrated in FIG. 8 when placed into a straight configuration. The cup 70 shaped containment area is formed from an open top 72 constructed and arranged for the introduction of the cork pieces within the containment area. A permeable bottom 74 is comprised of a plurality of openings 76 as illustrated in FIG. 7 to allow wine to permeate through yet retain the cork pieces within the cup 70 shaped containment area during the extraction thereof. The permeable bottom 74 allows the wine to remain in the bottle thus preventing spillage when the device is removed from the wine bottle 100. Furthermore, the cup bottom 74 employs a wiper seal 78 disposed about the periphery to assure that no cork pieces will remain attached to the inner sidewalls of the bottle neck by pushing the cork pieces downward wherein they can be captured by the cup shaped containment area. The wiper seal is of a flexible material such as rubber, latex or the like having a bevel shape to allow for ease of insertion and to provide a brush like action during insertion. Upon removal of the extraction tool, the wiper seal operates to clean the inside neck of the bottle.

In operation, should a cork break or otherwise leave debris within the bottle, the pieces will be either floating on the top of the wine or adhering to the inner neck of the bottle. Should wine be poured from the bottle, the consumer would then have to pick the pieces of cork from the bottle. If served at a restaurant, the patrons could spend time fishing the cork pieces out of the wine glass or outright refuse the bottle. Similar to a bottle, cork pieces may adhere to the side of the glass making it difficult to remove. Should the patron refuse the bottle, the restaurant would need to find another patron willing to take the open bottle or find another way of using the wine to prevent costly waste. To remove the cork pieces from the bottle, the extraction tool is unfolded wherein the lower portion 62 is straightened by placement in alignment with the upper portion 64. The cup 70 shaped containment area is placed through the neck of the bottle wherein the wiper seal 78 lightly engages the inner side walls of the bottle to dislodge any cork pieces causing them to fall into the wine. The high buoyancy of the cork maintains the cork pieces on the top surface of the wine. The cup 70 shaped containment area is then dipped into the wine and drawn upward so as to place the cork piece(s) in the cup as the extraction tool is removed from the bottle. During removal, any wine that is within the cup 70 shaped containment area is drained back into the bottle through the permeable bottom 74 leaving the cork piece(s) in the cup 70 for disposal. Typically the cork pieces stick together so that the user of the extraction tool is able to remove the pieces with a single insertion of the cup 70. This is particularly advantageous to a waiter that is serving fine wine at a restaurant. The patron who witnessed the cork break would have no reason not to accept the wine when the cork pieces are instantly removed and the patron need not fish the cork pieces from the wine. Once the wine has drained from the cup 70, the cork pieces will adhere to the inner side surface of the cup until rinsed out. This will allow the waiter to fold the extraction tool and store tool until the waiter returns to the prep station where the cup can be rinsed and the tool readied for further use.

Along the surface of the lever arm is an infrared wine thermometer 90. The wine thermometer includes an LED element 92 and a numerical display 94. The numerical display 94 demonstrates the temperature of the wine. The infrared thermometer is used to measure the surface temperature of the wine. If a bottle has been sitting in a 55 degree cellar and then placed in a room which has a temperature of 78 degrees, the bottle will warm up before the wine. Similarly, if a warm bottle is placed on ice, the bottle will warm up before the wine. The thermometer allows the user to determine the exact temperature of the wine either within the bottle or once placed into a glass for consumption. For instance, red wines are best served between 55-65 degrees. Rose wines are best served between 50-55 degrees. White wines are best served between 45-53 degrees.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A corkscrew device comprising:
a main body member having a first end and a second end;
a lever arm hingedly connected to said main body member, said lever arm including at least one notch constructed and arranged to operate as a fulcrum point against the neck of a wine body;
a helicoidal thread member connected to said main body member by a first pivot shaft, said thread available for being introducibly screwed into a cork to be removed from a bottle; and
an extraction tool member having a proximal end and a distal end, said proximal end connected to said first pivot shaft, said distal end having a cup shaped containment area;
whereby said helicoidal thread member is anchored into a wine cork for a fulcrum removal wherein said cup shaped containment member being constructed and arranged for extraction of cork pieces left within the bottle.

2. The corkscrew device according to claim 1, wherein said cup shaped containment member has an open top for introduction of wine holding cork piece and a permeable bottom for drainage of wine to prevent spillage.

3. The corkscrew device according to claim 1 including a wiper seal constructed an arranged to remove cork pieces from the inner sidewall of a wine bottle neck.

4. The corkscrew device according to claim 3 wherein said wiper seal is a beveled flexible material allowing ease of insertion into a bottle neck.

5. The corkscrew device according to claim 1 wherein said extraction tool member includes a lower body coupled along a pivot point to an upper body, said upper body coupled to said main body, said lower body extended into a straighten alignment stature with said upper body, wherein said lower body is foldable, in combination with said upper body, into a storage position within said main body side walls.

6. The corkscrew according to claim 1 including a knife blade pivotedly attached to said main body.

7. The corkscrew according to claim 1 including an infrared thermometer attached to said lever arm member.

8. The corkscrew according to claim 1 wherein said main body is ergonomically shaped to accommodate the contours of a user's hand.

9. The corkscrew according to claim 1 wherein said main body includes a clip for attachment to a belt.

10. The corkscrew according to claim 1 including a wire foil removal notch positioned along a distal end of said main member.
